(19) United States
(12) Patent Application Publication
(10) Pub. No.: US 2010/0053360 A1
(43) Pub. Date: Mar. 4, 2010

(54) IMAGE PROCESSING METHOD AND IMAGE PROCESSING APPARATUS

(75) Inventor: Naoyuki Hasegawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/548,052

(22) Filed: Aug. 26, 2009

(30) Foreign Application Priority Data
Aug. 28, 2008 (JP) 2008-220209

(51) Int. Cl. H04N 5/228

(52) U.S. Cl. 348/222.1; 348/E05.031

(57) ABSTRACT

An image processing method includes acquiring shooting data indicating a condition used for capturing image data, calculating an adaptation field size using data indicating an adaptation field angle and the acquired shooting data, executing filter processing on the image data according to the adaptation field size to calculate data indicating an adaptation state of a scene that is a shooting object of the image data, and calculating data indicating appearance of the scene using the data indicating the adaptation state.

### BACKGROUND OF THE INVENTION

1. Field of the Invention

The present invention relates to a method and an apparatus applicable to the dynamic range compression technology, such as the High Dynamic Range Imaging technology (i.e., HDR imaging technology).

2. Description of the Related Art

Nowadays, due to the wide-spread use of digital cameras, the conduct “take a picture with a digital camera” is an ordinary conduct for many users. When a user captures an outdoor scene with a digital camera, the scene (i.e., a shooting object) may have a luminance range wider than an image-capturable luminance range of the camera. In such a case, the camera cannot record gradation information of an object if the object is out of the image-capturable luminance range. As a result, clipped whites (a loss of highlight detail) or crushed blacks (a loss of shadow detail) may occur. For example, in a case where the exposure of the camera is adjusted for a target person who is in the open air in fine weather, the background (e.g., the sky and clouds) of the person may be overexposed while the shade of a tree may be underexposed.

However, the human vision has “local adaptation” characteristics capable of switching the adaptation state according to the brightness of a target viewing area to perceive the brightness and the color of the object. Therefore, the gradation can be appropriately perceived regardless of the brightness or darkness of the place. Therefore, the impression obtainable by a user who views a scene may be different from the impression obtainable when the user views a captured image. In such a case, the digital camera user feels uncomfortable.

The HDR imaging technology is one of the technologies capable of solving the above-described problem. The HDR imaging technology is roughly classified into the HDR image capture technology and the HDR image reproduction technology. The HDR image capture technology can widen an image-capturable dynamic range and record gradation information of a luminance range where clipped whites or crushed blacks have occurred. For example, as an example method, a plurality of images captured at respective different exposure values can be combined. In the following description, the image acquired by the HDR image capture technology is referred to as an HDR image.

The HDR image reproduction technology is one of the dynamic range compression technologies, which enables a display/output device having a narrow dynamic range to reproduce an HDR image having a wide dynamic range. For example, as an example method, low-frequency components of an HDR image can be compressed. In this manner, the HDR imaging technology can reduce clipped whites or crushed blacks by widening the dynamic range using the above-described capture technology and the corresponding reproduction technology.

There are various methods relating to the above-described dynamic range compression technology that have been conventionally proposed. For example, the dynamic range compression technology “iCAM06” introduced by J. Kuang, et al., enables a display/output device to reproduce an image so as to reflect the impression obtained by a user when the scene is viewed by user's eyes.

The dynamic range compression technology “iCAM06” includes processing for simulating the appearance of brightness/color that was perceived by human eyes in a shooting scene based on an HDR image, converting a simulation result into brightness/color values that can be reproduced by an output device, and finally generating signal values for a display/output device.

In this case, the appearance of the scene can be simulated based on the HDR image using an appropriate “vision model” that represents the mechanism of the human eyes in perceiving the brightness/color. To this end, the dynamic range compression technology “iCAM06” uses a vision model capable of reflecting the above-described local adaptation characteristics to accurately simulate the brightness/color that was perceived by the human eyes.

In the above-described dynamic range compression technology “iCAM06”, to simulate the appearance of the scene based on the HDR image considering the local adaptation characteristics, it is necessary to define an area where the local adaptation occurs (i.e., adaptation field size) with the number of pixels in the HDR image. According to the dynamic range compression technology “iCAM06”, information indicating how the human eyes observe the scene is unknown and, thus, the adaptation field size in the scene is constantly allocated for every HDR image in such a way as to have a predetermined ratio (e.g., 50%) relative to the HDR image width. However, the adaptation field size is dependent on the distance of the scene from the observation point. Therefore, if the adaptation field size is constantly determined for every captured image, the appearance of the scene cannot be accurately simulated.

### SUMMARY OF THE INVENTION

The present invention is directed to the HDR imaging technology, which can accurately simulate the appearance of a scene and accurately reproduce an image reflecting the impression obtained by a user who viewed the scene.

According to an aspect of the present invention, an image processing method includes acquiring shooting data indicating a condition used for capturing image data, calculating an adaptation field size using data indicating an adaptation field angle and the acquired shooting data, executing filter processing on the image data according to the adaptation field size to calculate data indicating an adaptation state of a scene that is a shooting object of the image data, and calculating data indicating appearance of the scene using the data indicating the adaptation state.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a block diagram illustrating a configuration of an image processing apparatus according to a first exemplary embodiment.

FIG. 2 is a flowchart illustrating a procedure of processing that can be performed by the image processing apparatus according to the first exemplary embodiment.

FIG. 3 illustrates an example display of a graphical user interface (i.e., GUI).

FIG. 4 illustrates a configuration of an image file.

FIG. 5 illustrates a relationship between data and processing that can be executed by the image processing apparatus according to the first exemplary embodiment.

FIG. 6 is a flowchart illustrating details of the processing that can be executed by the image processing apparatus in step S202 illustrated in FIG. 2.

FIG. 7 illustrates a relationship among adaptation field angle θ [°], image width W [pixel], optical sensor width d_{w} [mm], lens focal length f [mm], enlargement rate m [%], and adaptation field size S [pixel].

FIG. 8 is a flowchart illustrating details of the processing that can be executed by the image processing apparatus in step S203 illustrated in FIG. 2.

FIG. 9 illustrates a change in the degree of blur with respect to data indicating an adaptation state in accordance with a change in the shooting distance.

FIG. 10 is a flowchart illustrating details of processing that can be executed by the image processing apparatus in step S204 illustrated in FIG. 2.

FIG. 11 illustrates an example display of the UI.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Various exemplary embodiments, features, and aspects of the invention will be described in detail below with reference to the drawings.

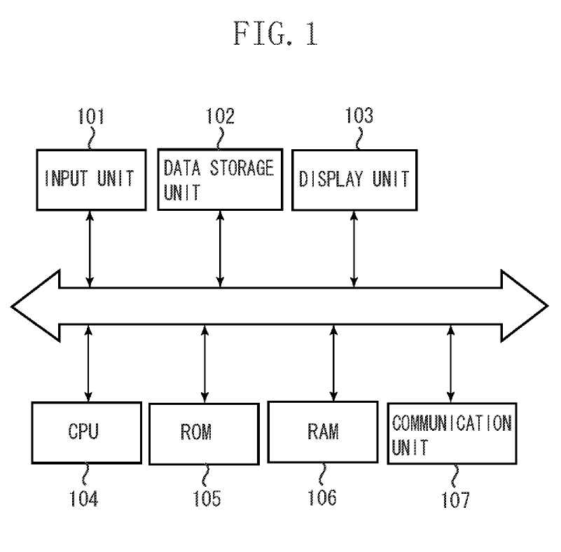

A first exemplary embodiment of the present invention is described below. FIG. 1 is a block diagram illustrating a configuration of an image processing apparatus according to the first exemplary embodiment. An input unit 101 illustrated in FIG. 1 is a device enabling users to input instructions and data. The input unit 101 includes a keyboard and a pointing device. The pointing device is, for example, a mouse, a trackball, a trackpad, or a tablet. In a case where the image processing apparatus according to the present exemplary embodiment is applied to a conventional device (e.g., a digital camera or a printer), a button or a mode dial can function as a pointing device. If the keyboard is configured as a software keyboard, a user can input characters and numerical values by operating the button, the mode dial, or the above-described pointing device.

A data storage unit 102 can store image data. The data storage unit 102 is, for example, a hard disk, a floppy disk, a compact disc-ROM (i.e., CD-ROM), a CD-recordable (i.e., CD-R), a CD-rewritable (i.e., CD-RW), a digital versatile disc (i.e., DVD (including DVD-ROM, DVD-R, and DVD+R)), a memory card, a CompactFlash (i.e., CF) card, a SmartMedia, a SD card, a memory stick, an xD picture card, or a universal serial bus (i.e., USB) memory. The data storage unit 102 can further store programs and other data in addition to the image data. Further, a random access memory (i.e., RAM) 106 can be partly used as the data storage unit 102. Alternatively, the data storage unit 102 can be provided in an external device connected via a communication unit 107. In other words, the data storage unit 102 can be virtually configured as part of an external device accessible via the communication unit 107.

A display unit 103 can display images to be subjected or having been subjected to image processing, or can display GUI or comparable graphic images. In general, the display unit 103 is a cathode ray tube (i.e., CRT) or a liquid crystal display device. The display unit 103 may be an external display device connected to the apparatus via a cable or may be a touch screen. In this case, any input entered via the touch screen can be processed as an input via the input unit 101.

A central processing unit (i.e., CPU) 104 can perform control relating to each processing to be performed by the apparatus. A read only memory (i.e., ROM) 105 and the RAM 106 can provide programs, data, and work area required for the processing to the CPU 104. In a case where a control program required for the below-described processing is stored in the data storage unit 102 or in the ROM 105, the control program is loaded into the RAM 106 before the CPU 104 executes the control program. Further, when the program is transmitted to the apparatus via the communication unit 107, the program is temporarily stored in the data storage unit 102 before the program is loaded into the RAM 106. Alternatively, the program can be directly supplied from the communication unit 107 to the RAM 106 and executed by the CPU 104.

The communication unit 107 can serve as a communication interface (i.e., I/F) between a plurality of devices. The communication unit 107 is, for example, a wired communication device using Ethernet, USB, IEEE1284, IEEE1394, or the telephone circuit or a wireless communication device using infrared (IrDA), IEEE802.11a, IEEE802.11b, IEEE802.11g, Bluetooth, or Ultra Wide Band (i.e., UWB).

According to the configuration illustrated in FIG. 1, all of the input unit 101, the data storage unit 102, and the display unit 103 are incorporated in a single apparatus body. However, these units can be separate devices connected via a conventional communication path if they can realize functions similar to those described above.

Although not illustrated, the system configuration according to the present invention can be modified in various ways.

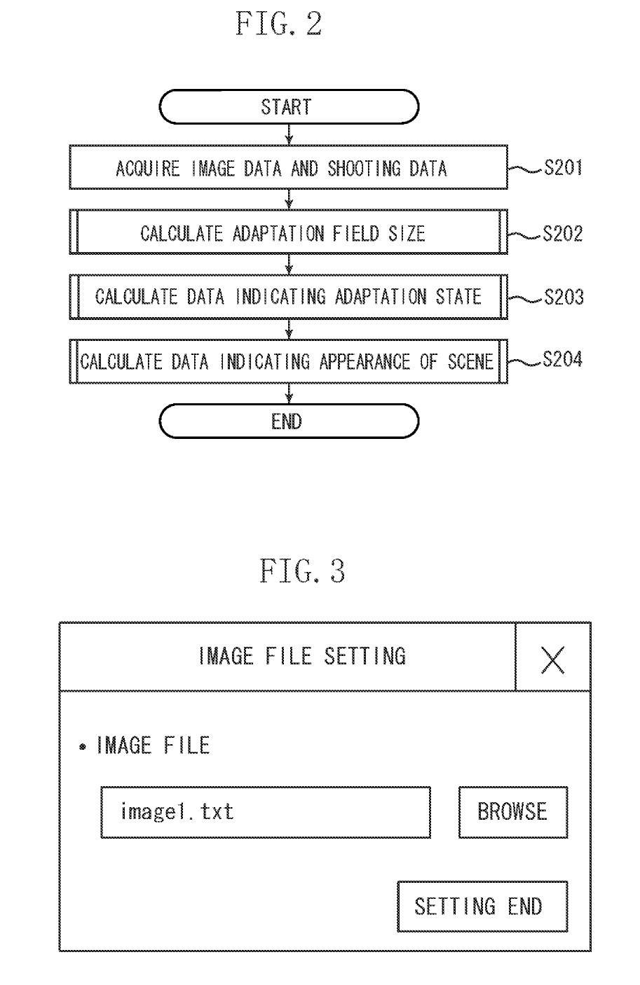

Example processing that can be executed by the image processing apparatus according to the first exemplary embodiment of the present invention is described below. FIG. 2 is a flowchart illustrating a procedure of the processing that can be executed by the image processing apparatus according to the first exemplary embodiment of the present invention.

In step S201, the CPU 104 causes the display unit 103 to display a user interface (i.e., UI) illustrated in FIG. 3. Then, the CPU 104 reads, from the data storage unit 102, image data and shooting data of an image file instructed by a user and entered via the input unit 101. The CPU 104 stores the acquired image data and shooting data in the RAM 106. The processing executed in step S201 is an example of an acquisition process according to the present invention.

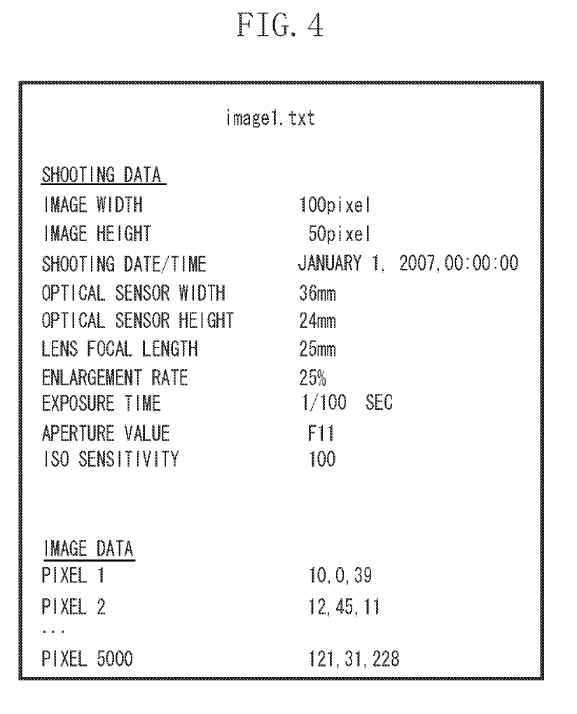

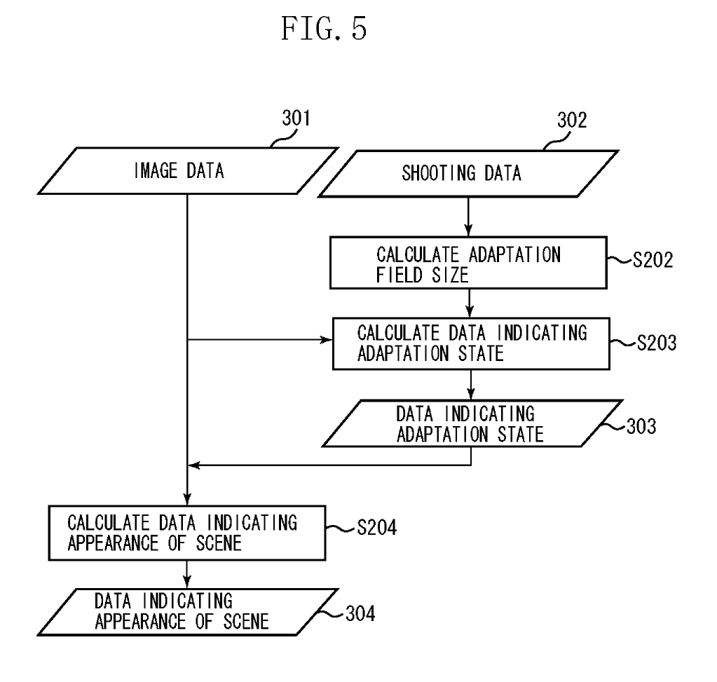

FIG. 4 illustrates a configuration of an image file. The image data included in the image file is the data recording 8-bit RGB values of all pixels, as illustrated in FIG. 4. The shooting data included in the image file is the data recording image size and shooting operation information (e.g., image width, image height, shooting date/time, optical sensor width, optical sensor height, lens focal length, enlargement rate, exposure time, aperture value, and ISO sensitivity), as illustrated in FIG. 4.

In step S202, the CPU 104 reads an adaptation field angle stored beforehand in the data storage unit 102. The CPU 104 calculates an adaptation field size using the read adaptation field angle and the shooting data stored in the RAM 106. In the present exemplary embodiment, the adaptation field indicates an area where the human vision can be locally adapted. The processing content in step S202 is described below in more detail. The processing executed in step S202 is an example of an adaptation field size calculation process according to the present invention.

In step S203, the CPU 104 reads the image data and the shooting data stored in the RAM 106 (see step S201) and converts the image data into tri-stimulus values (i.e., absolute XYZ values) based on the read shooting data. Next, the CPU 104 calculates data indicating an adaptation state using the converted absolute XYZ values and the adaptation field size calculated in step S202. In the present exemplary embodiment, tri-stimulus values (i.e., absolute XYZ values) representing adaptation of the human vision is the data indicating the adaptation state. The processing content in step S203 is described below in more detail. The processing executed in step S23 is an example of an adaptation state calculation process according to the present invention.

In step S204, the CPU 104 reads the absolute XYZ values calculated in step S203 and the data indicating the adaptation state. Then, the CPU 104 calculates data indicating the appearance of the scene using the read absolute XYZ values and the data indicating the adaptation state. The CPU 104 stores the calculated data indicating the appearance of the scene in the data storage unit 102. In the present exemplary embodiment, a color/brightness value representing the appearance of the scene is the data indicating the appearance of the scene. The processing content in step S204 is described below in more detail. The processing executed in step S204 is an example of a scene appearance calculation process according to the present invention.

FIG. 5 illustrates a relationship between the data and the processing that can be executed by the image processing apparatus according to the present exemplary embodiment. More specifically, respective steps S202 to S204 illustrated in FIG. 5 correspond to the steps S202 to S204 illustrated in FIG. 2. Image data 301 in FIG. 5 is the data having been read in step S201 illustrated in FIG. 2. Shooting data 302 in FIG. 5 is the data having been read in step S201 illustrated in FIG. 2. Data indicating the adaptation state 303 in FIG. 5 is the data having been calculated in step S203 illustrated in FIG. 2. Data indicating the appearance of scene 304 in FIG. 5 is the data having been calculated in step S204 illustrated in FIG. 2.

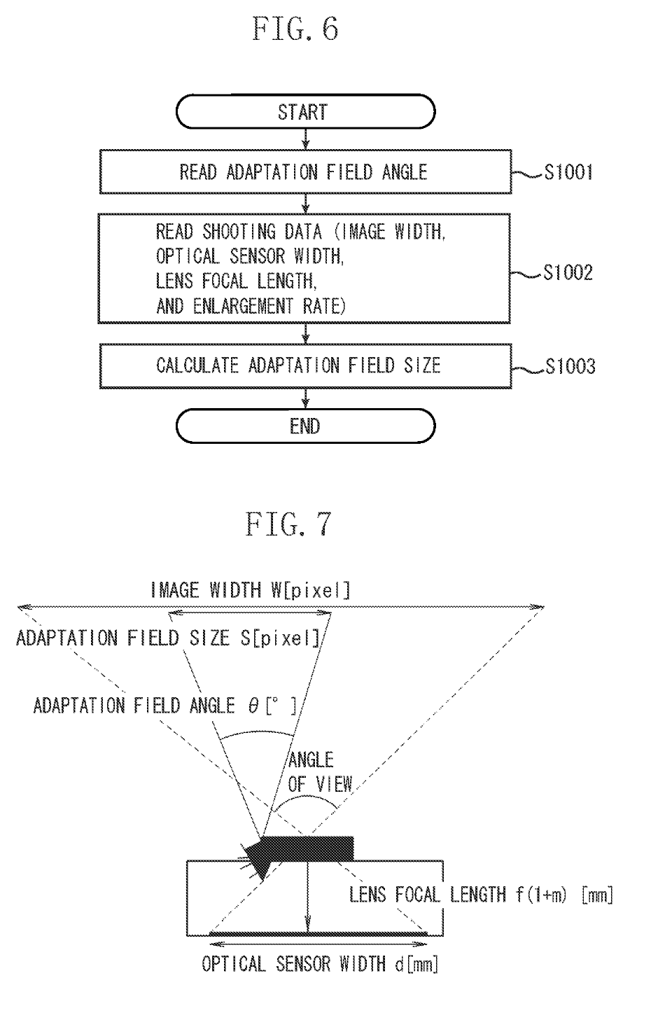

FIG. 6 is a flowchart illustrating details of the processing that can be executed by the CPU 104 in step S202 illustrated in FIG. 2. In step S1001, the CPU 104 reads an adaptation field angle from the data storage unit 102 that stores the adaptation field angle beforehand.

In step S1002, the CPU 104 reads an image width, an optical sensor width, a lens focal length, and an enlargement rate from the shooting data stored in the RAM 106 in step S201.

In step S1003, the CPU 104 calculates an adaptation field size S [pixel] defined by the following formula (1) using the adaptation field angle θ [°], the image width W [pixel], the optical sensor width d_{w} [mm], the lens focal length f [mm], and the enlargement rate m [%], which are read in steps S1001 and S1002. The CPU 104 stores the calculated adaptation field size S in the RAM 106. Formula (1) can be derived from the relationship between the adaptation field angle θ [°], the image width W [pixel], the optical sensor width d_{w} [mm], the lens focal length f [mm], the enlargement rate m [%], and the adaptation field size S [pixel], which are illustrated in FIG. 7. In formula (1), the image width and the optical sensor width can be replaced with the image height and the optical sensor height.

$$S [ pixel ] = \frac{tan θ / 2}{{d}_{w} / 2 f ( 1 + m )} \times W \qquad ( 1 )$$

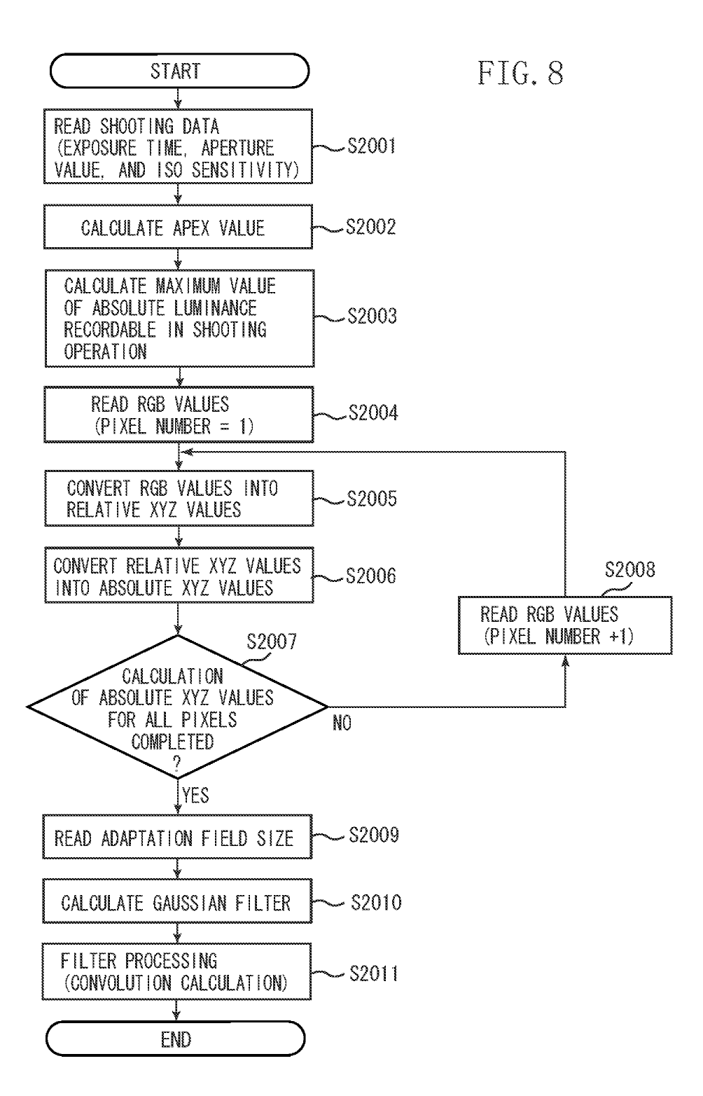

FIG. 8 is a flowchart illustrating details of the processing that can be executed by the CPU 104 in step S203 illustrated in FIG. 2. In step S2001, the CPU 104 reads the exposure time, the aperture value, and the ISO sensitivity from the shooting data stored in the RAM 106 in step S201.

In step S2002, the CPU 104 calculates APEX values AV, TV, SV, and BV defined by the following formula (2) using the exposure time T[s], the aperture value F, and the ISO sensitivity ISO, which have been read in step S2001.

AV(Aperture Va [symbol] ue)=2 [symbol] og₂(F)

TV(Shutter Speed Va [symbol] ue)=− [symbol] og₂(T)

SV(Fi [symbol] m Speed Va [symbol] ue)= [symbol] og₂(ISO/3.0)

BV(Brightness Va [symbol] ue)=AV+TV−SV (2)

In step S2003, the CPU 104 calculates a maximum value Lumₘₐₓ[cd/m²] of an absolute luminance recordable in a shooting operation, which is defined by the following formula (3), using the APEX value BV calculated in step S2002.

Lumₘₐₓ=(3.426×2^{BV})/18.0×201.0 (3)

In step S2004, the CPU 104 reads RGB values of the pixel number 1 from the image data stored in the RAM 106 in step S201.

In step S2005, the CPU 104 converts the RGB values of the pixel number read in step S2004 or step S2008 into relative XYZ values XYZᵣₗₜ according to the following formula (4).

$$[ \begin{matrix}{X}_{rlt} \\ {Y}_{rlt} \\ {Z}_{rlt}\end{matrix} ] = [ \begin{matrix}0.41 & 0.36 & 0.18 \\ 0.21 & 0.71 & 0.07 \\ 0.02 & 0.12 & 0.95\end{matrix} ] [ \begin{matrix}R \\ G \\ B\end{matrix} ] \qquad ( 4 )$$

In step S2006, the CPU 104 converts the relative XYZ values XYZᵣₗₜ of the pixel number (i.e., the converted values obtained in step S2005) into absolute XYZ values XYZ_{abs}, according to the following formula (5), using the maximum value Lumₘₐₓ[cd/m²] of the absolute luminance recordable in a shooting operation calculated in step S2003. The CPU 104 stores the absolute XYZ values XYZ_{abs} in the RAM 106.

$$[ \begin{matrix}{X}_{abs} \\ {Y}_{abs} \\ {Z}_{abs}\end{matrix} ] = [ \begin{matrix}{X}_{rlt} / 255 \times {Lum}_{max} \\ {Y}_{rlt} / 255 \times {Lum}_{max} \\ {Z}_{rlt} / 255 \times {Lum}_{max}\end{matrix} ] \qquad ( 5 )$$

In step S2007, the CPU 104 determines whether the calculation of the absolute XYZ values for all pixels has been completed. If the CPU 104 determines that the calculation of the absolute XYZ values for all pixels has not been completed (NO in step S2007), the processing proceeds to step S2008. If the CPU 104 determines that the calculation of the absolute XYZ values for all pixels has been completed (YES in step S2007), the processing proceeds to step S2009.

In step S2008, the CPU 104 reads RGB values of the next pixel number from the image data stored in the RAM 106 in step S201. Then, the processing returns to step S2005.

In step S2009, the CPU 104 reads the adaptation field size stored in the RAM 106 in step S1003.

In step S2010, the CPU 104 calculates data indicating a Gaussian filter, which is defined by the following formula (6), using the adaptation field size S read in step S2009. In formula (6), coordinate values (a, b) represent the pixel position relative to the center (0, 0) of the filter. In the present exemplary embodiment, a half of the adaptation field size S is allocated to the variance of the Gaussian filter to design a filter corresponding to the adaptation field size. The range in which the filter processing is performed is set to −S to S, which includes approximately 95% of an integral value of the Gaussian function.

$$Filter ( a , b ) = \frac{1}{k} exp \{ - \frac{{a}^{2} + {b}^{2}}{2 {( \frac{S}{2} )}^{2}} \} , - S ≦ a , b ≦ S \\ k = {\sum }_{a = - S}^{S} {\sum }_{b = - S}^{S} exp \{ - \frac{{a}^{2} + {b}^{2}}{2 {( \frac{S}{2} )}^{2}} \} \qquad ( 6 )$$

In step S2011, the CPU 104 executes filtering processing (e.g., discrete convolution operation) defined by the following formula (7), based on the absolute XYZ values calculated in step S2006 and the Gaussian filter calculated in step S2010. The CPU 104 stores the calculation result (i.e., the absolute XYZ values) in the RAM 106. In formula (7), coordinate values (x, y) represent the pixel position where the filter processing is to be executed. M represents the number of pixels with respect to the image width. N represents the number of pixels with respect to the image height. Img(x, y) represents absolute XYZ values not subjected to the convolution operation. FilteredImg(x, y) represents absolute XYZ values having been subjected to the convolution operation.

$$FilteredImg ( x , y ) = {\sum }_{a = - S}^{S} {\sum }_{b = - S}^{S} Img ( x - a , y - b ) Filter ( a , b ) \\ x = 0 , … M - 1 , y - 0 , … N - 1 \qquad ( 7 )$$

In the present exemplary embodiment, absolute XYZ values that can be obtained by executing Gaussian filter processing on the absolute XYZ values of all pixels, which can be obtained through the above-described steps S2001 to S2011, is the data indicating the adaptation state.

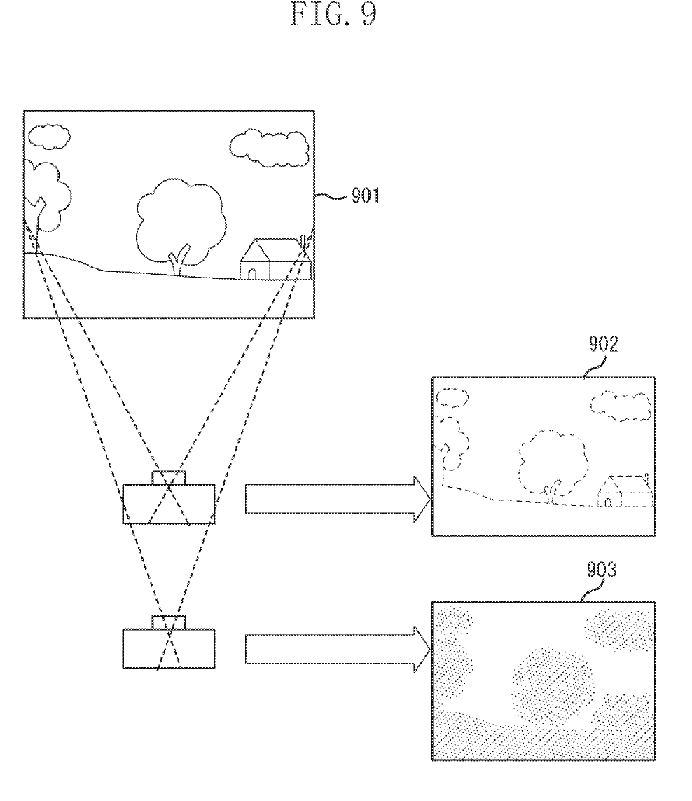

FIG. 9 illustrates a change in the degree of blur with respect to the data indicating the adaptation state in accordance with a change in the shooting distance. Two images 902 and 903 illustrated in FIG. 9 can be obtained from the same scene 901 if they are captured at different shooting distances (i.e., when the angle of view of the digital camera that captures the same scene 901 is changed). When the shooting distance is short, the degree of blur becomes weak (see the image 902 in FIG. 9). When the shooting distance is long, the degree of blur becomes strong (see the image 903 in FIG. 9).

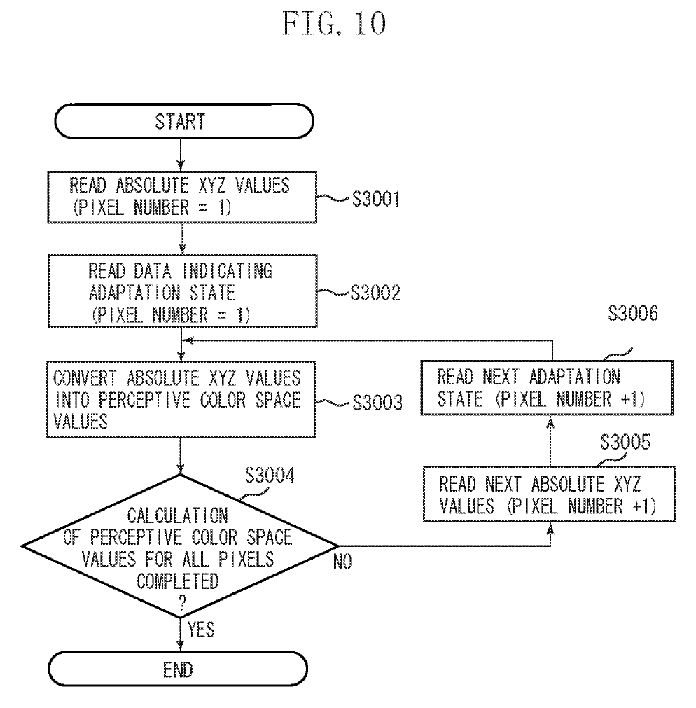

FIG. 10 is a flowchart illustrating details of the processing that can be executed by the CPU 104 in step S204 illustrated in FIG. 2. In step S3001, the CPU 104 reads the absolute XYZ values of the pixel number 1 stored in the RAM 106 in step S2006.

In step S3002, the CPU 104 reads XYZ values indicating an adaptation state of the pixel number 1 stored in the RAM 106 in step S2011.

In step S3003, the CPU 104 converts the absolute XYZ values read in step S3001 into perceptive color space values, using the XYZ values indicating the adaptation state read in step S3002. In the present exemplary embodiment, the CPU 104 converts the absolute XYZ values into the perceptive color space values according to the above-described dynamic range compression technology “iCAM06.” The CPU 104 stores the obtained perceptive color space values in the data storage unit 102. According to the dynamic range compression technology “iCAM06”, the perceptive color space values can be expressed with three types of parameters I, P, and T, which represent luminosity (lightness), saturation, and hue, respectively, that the human eyes can perceive.

According to the dynamic range compression technology “iCAM06,” the CPU 104 performs filter processing on the absolute XYZ values converted from the image data to extract low-frequency components. The CPU 104 generates high-frequency components as the difference between the original absolute XYZ values and the extracted low-frequency components.

Then, the CPU 104 compresses the extracted low-frequency components using the above-described data indicating the adaptation state, as local adaptation processing. Then, the CPU 104 combines the compressed low-frequency components with the above-described high-frequency components to obtain the perceptive color space values I, P, and T. In the present exemplary embodiment, the CPU 104 can calculate the data indicating the adaptation state based on an accurate adaptation field size referring to formula (1). Therefore, the CPU 104 can accurately simulate the appearance of the scene (i.e., can calculate the perceptive color space values I, P, and T).

In step S3004, the CPU 104 determines whether the calculation of the perceptive color space values for all pixels has been completed. If the CPU 104 determines that the calculation of the perceptive color space values for all pixels has not been completed (NO in step S3004), the processing proceeds to step S3005. If the CPU 104 determines that the calculation of the perceptive color space values for all pixels has been completed (YES in step S3004), the CPU 104 terminates the processing of the routine illustrated in FIG. 10.

In step S3005, the CPU 104 reads absolute XYZ values of the next pixel number stored in the RAM 106 in step S2006.

In step S3006, the CPU 104 reads XYZ values indicating an adaptation state of the next pixel number stored in the RAM 106 in step S2011. Then, the processing returns to step S3003.

As described above, in the present exemplary embodiment, the CPU 104 uses the information relating to the image data capturing operation to accurately associate the adaptation field size in the image capturing scene with the number of pixels in the image data. Thus, the CPU 104 can allocate an accurate adaptation field size to the vision model that takes local adaptation characteristics of the human vision into consideration. Therefore, in the dynamic range compression technology “iCAM06” or “iCAM”, an accurate adaptation field size can be allocated to a processing unit that simulates the appearance of the scene based on an HDR image using the vision model that takes local adaptation characteristics of the human vision. Thus, the present exemplary embodiment can improve the accuracy of a simulation result and can accurately output/display an image reflecting the impression obtained by a user who viewed the scene.

Next, a modified example of the first exemplary embodiment according to the present invention is described below. In the above-described first exemplary embodiment, the image file can store 8-bit RGB values of all pixels as image data. The image file can further store shooting data, such as image width, image height, shooting date/time, optical sensor width, lens focal length, enlargement rate, exposure time, aperture value, and ISO sensitivity. However, the data type and the data format are not limited to the above-described examples.

For example, the image file may store 16-bit RGB values. The image file may store absolute XYZ values of respective pixels that can be calculated beforehand. Instead of storing the optical sensor width, the lens focal length, and the enlargement rate (i.e., the information required for calculating the angle of view in a shooting operation), the image file may store the angle of view in a shooting operation that can be calculated beforehand. Instead of storing the exposure time, the aperture value, and the ISO sensitivity, the image file may store a maximum value of the absolute luminance in the scene that can be measured using a luminance meter. Further, the image file format can be a conventionally known format, such as Exchange Image File format (i.e., Exif format). The image data and the shooting data can be recorded in different files. The optical sensor width is an example of the optical sensor size according to the present invention.

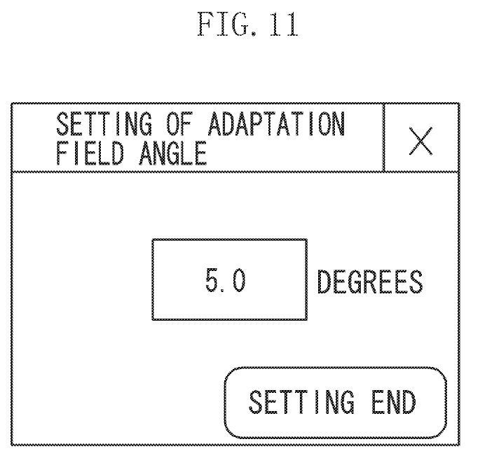

In the above-described first exemplary embodiment, the CPU 104 uses the adaptation field angle stored in the data storage unit 102 beforehand, as an example method. However, any other method capable of setting the adaptation field angle can be used. For example, a method for causing the display unit 103 to display a UI illustrated in FIG. 11 and reading an adaptation field angle entered by a user via the input unit 101 can be used.

In the above-described first exemplary embodiment, the CPU 104 calculates the adaptation field size defined by formula (1) using the adaptation field angle, the image width, the optical sensor width, the lens focal length, and the enlargement rate. However, any other method capable of calculating the adaptation field size using shooting operation information can be used. For example, the CPU 104 can calculate the adaptation field size using the angle of view α [°] as the shooting operation information. In this case, the CPU 104 can calculate the adaptation field size S [pixel] defined by the following formula (8).

$$S [ pixel ] = \frac{tan θ / 2}{tan α / 2} \times W \qquad ( 8 )$$

In the above-described first exemplary embodiment, the CPU 104 converts the RGB values of each pixel into relative XYZ values XYZᵣₗₜ according to formula (4). However, any other method capable of converting the image data into XYZ values can be used. For example, in the conversion from the RGB values into the XYZ values, the values in the conversion matrix defined by formula (4) can be changed if it is desired to improve the calculation accuracy.

In the above-described first exemplary embodiment, as an example method for converting the relative XYZ values into the absolute XYZ values, the CPU 104 calculates the APEX values based on the shooting data and calculates the maximum value of the absolute luminance recordable in a shooting operation. Then, the CPU 104 converts the relative XYZ values into the absolute XYZ values according to formula (5). However, any other method capable of converting image data into absolute XYZ values can be used. For example, the CPU 104 can calculate the maximum value of the absolute luminance recordable in a shooting operation beforehand according to the method described in the first exemplary embodiment and store the calculated value as part of the shooting data. The CPU 104 can read the maximum value from the storage unit if it is necessary.

In the above-described first exemplary embodiment, as a method for calculating a filter usable for calculating the data indicating the adaptation state, the CPU 104 calculates the data indicating the Gaussian filter, which is defined by formula (6), using the adaptation field size S. However, the filter is not limited to the above-described type. For example, for the purpose of quickly accomplishing the processing, the range in which the filter processing is performed can be fixed to a constant range regardless of the adaptation field size S.

In the above-described first exemplary embodiment, the CPU 104 stores the perceptive color space values in the data storage unit 102 as the data indicating the appearance of the scene. However, the CPU 104 may store any data calculated or derived from the perceptive color space values. For example, a processing unit capable of converting the data indicating the appearance of the scene according to the dynamic range compression technology “iCAM06” into a signal value for an output device can convert perceptive color space values into RGB values of the output device and store the obtained RGB values in the data storage unit 102.

Next, a second exemplary embodiment of the present invention is described below. In the above-described first exemplary embodiment, as an example method for calculating the data indicating the adaptation state, the CPU 104 executes the Gaussian filter processing on the absolute XYZ values of the image data. However, the CPU 104 can execute another type of low-pass filter processing on the image data to extract the low-frequency components from the image data. For example, the CPU 104 can use a bilateral filter.

As the second exemplary embodiment of the adaptation state calculation method, a method for executing simple average filter processing on image data is described below. The following formula (9) indicates an example adaptation state calculation method usable in this case.

$$Filtered Img ( x , y ) = \frac{1}{4 {S}^{2}} {\sum }_{a = - S}^{S} {\sum }_{b = - S}^{S} Img ( x + a , x + b ) , \\ x = 0 , … M - 1 , y = 0 , … N - 1 \qquad ( 9 )$$

Further, the filter can be configured into an elliptic shape extending in the horizontal direction considering the fact that the angle of field in the horizontal direction is greater than the angle of field in the vertical direction with respect to the human vision visible by a single eye. The following formula (10) indicates an example adaptation state calculation method usable in this case. In formula (10), k_{w} represents the ratio of the pixel number of the major axis of the ellipse to the adaptation field size S, and kₕ represents the ratio of the pixel number of the minor axis of the ellipse to the adaptation field size S.

$$Filtered Img ( x , y ) = \frac{1}{4 {k}_{w} {k}_{h} {S}^{2}} {\sum }_{a = - S}^{S} {\sum }_{b = - S}^{S} Img ( x + a , x + b ) , \\ x = 0 , … M - 1 , y = 0 , … N - 1 \qquad ( 10 )$$

A computer can execute a program stored in a RAM or a ROM to realize the functional units and steps described in the above-described exemplary embodiment of the present invention. In this case, the present invention encompasses the program and a computer readable storage medium storing the program.

The present invention can be embodied, for example, as a system, an apparatus, a method, a program, or a storage medium. The present invention can be applied to an apparatus configured as an independent device.

The present invention supplies, directly or from a remote place, a software program that realizes the functions of the above-described exemplary embodiment to a system or an apparatus. A computer of the system or the apparatus can read and execute a supplied program code to attain the invention.

Accordingly, the program code itself installed on the computer to enable the computer to realize the functional processing according to the present invention can realize the present invention. Namely, the present invention encompasses the computer program itself that can realize the functional processing according to the present invention. In this case, equivalents of programs (e.g., object code, interpreter program, and OS script data) are usable if they possess comparable functions.

The computer can execute the read program to realize the functions of the above-described exemplary embodiments. An operating system (OS) or other application software running on a computer can execute part or all of actual processing based on instructions of the program to realize the functions of the above-described exemplary embodiments.

The program code read out of a storage medium can be written into a memory of a function expansion board inserted in a computer or into a memory of a function expansion unit connected to the computer. In this case, based on instructions of the program, a CPU provided on the function expansion board or the function expansion unit can execute part or all of the processing to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-220209 filed Aug. 28, 2008, which is hereby incorporated by reference herein in its entirety.

What is claimed is:

1. An image processing method comprising:
acquiring shooting data indicating a condition used for capturing image data;
calculating an adaptation field size using data indicating an adaptation field angle and the acquired shooting data;
executing filter processing on the image data according to the adaptation field size to calculate data indicating an adaptation state of a scene that is a shooting object of the image data; and
calculating data indicating appearance of the scene using the data indicating the adaptation state.

2. The image processing method according to claim 1, wherein the shooting data includes at least one of information indicating an image width and information indicating an image height.

3. The image processing method according to claim 1, wherein the shooting data includes information required to calculate an angle of view used for capturing the image data.

4. The image processing method according to claim 1, wherein the shooting data includes information indicating an angle of view used for capturing the image data.

5. The image processing method according to claim 3, wherein the information required to calculate the angle of view includes information indicating an optical sensor size, information indicating a lens focal length, and information indicating an enlargement rate.

6. The image processing method according to claim 1, further comprising executing processing for extracting a low-frequency component from the image data using a low-pass filter.

7. The image processing method according to claim 6, wherein the low-pass filter is a Gaussian filter or a bilateral filter.

8. The image processing method according to claim 6, wherein the low-pass filter has a horizontal size greater than a vertical size thereof.

9. The image processing method according to claim 1, further comprising calculating data indicating the appearance of the scene based on a vision model that takes local adaptation characteristics of the human vision into consideration.

10. An image processing apparatus comprising:
an acquisition unit configured to acquire shooting data indicating a condition used for capturing image data;
an adaptation field size calculation unit configured to calculate an adaptation field size using data indicating an adaptation field angle and the shooting data acquired by the acquisition unit;
an adaptation state calculation unit configured to execute filter processing on the image data according to the adaptation field size to calculate data indicating an adaptation state of a scene that is a shooting object of the image data; and
a scene appearance calculation unit configured to calculate data indicating appearance of the scene using the data indicating the adaptation state.

11. A computer-readable storage medium storing a program for causing a computer to execute image processing, the program comprising:
computer-executable instructions for acquiring shooting data indicating a condition used for capturing image data;
computer-executable instructions for calculating an adaptation field size using data indicating an adaptation field angle and the acquired shooting data;
computer-executable instructions for executing filter processing on the image data according to the adaptation field size to calculate data indicating an adaptation state of a scene that is a shooting object of the image data; and
computer-executable instructions for calculating data indicating appearance of the scene using the data indicating the adaptation state.
